(19) United States
(12) Patent Application Publication
(10) Pub. No.: US 2022/0015281 A1
(43) Pub. Date: Jan. 20, 2022

(54) SEED DEVELOPMENT ENVIRONMENT SYSTEM

(71) Applicant: WoVa Labs, Inc., Twentynine Palms, CA (US)

(72) Inventors: Douglas Evans, Twentynine Palms, CA (US); Philip Rose, Sydney (AU); Richard Harrod, Sydney (AU); David Knott, Sydney (AU); Yaron Sheba, Mountain View, CA (US); Giles Matthew Lowe, Saratoga, CA (US); John Stewart Caldwell, San Jose, CA (US); Aarushi Abraham Karimpanal, San Jose, CA (US); Alyssa Reyes Biscocho, San Jose, CA (US); Gidon Wise, New York, NY (US); Paul Naddaff, Newton, MA (US)

(21) Appl. No.: 17/375,906

(22) Filed: Jul. 14, 2021

Related U.S. Application Data
(60) Provisional application No. 63/053,363, filed on Jul. 17, 2020.
(60) Provisional application No. 63/053,369, filed on Jul. 17, 2020.
(60) Provisional application No. 63/053,372, filed on Jul. 17, 2020.

(51) Int. Cl. A01C 1/02; A01G 7/04

(52) U.S. Cl. CPC A01C 1/02; A01G 7/045

(57) ABSTRACT

Providing a seed development environment is disclosed, including by: obtaining a seed type associated with seeds that have been deposited into a seed development environment device; determining an environmental control sequence corresponding to the seed type, wherein the environmental control sequence includes a plurality of target hydration levels for a plurality of seed development phases; and executing the environmental control sequence corresponding to the seed type, including at least by providing the plurality of target hydration levels using a hydration system and by adjusting hydration in the seed development environment device based on feedback from a hydration sensor that is included in the seed development environment device

### CROSS REFERENCE TO OTHER APPLICATIONS

This application claims priority to U.S. Provisional Patent Application No. 63/053,363, entitled SPROUTING DEVICE WITH MODULAR TRAYS AND HYDRATION COMPONENTS filed Jul. 17, 2020, and claims priority to U.S. Provisional Patent Application No. 63/053,369, entitled SPROUTING DEVICE WITH MANUAL HYDRATION filed Jul. 17, 2020, and claims priority to U.S. Provisional Patent Application No. 63/053,372, entitled SPROUTING DEVICE WITH AUTOMATED HYDRATION filed Jul. 17, 2020, each of which is incorporated herein by reference for all purposes.

### BACKGROUND OF THE INVENTION

Conventionally, seeds are manually soaked in a container, rinsed, and left alone, potentially repeatedly, until sprouts emerge. However, these steps are laborious to perform. More so, each step may require a variable length of time depending on various factors such as the type of seeds, the weather, the type of the container, and the size of the container, and the knowledge of such lengths of time may not be readily available to the average sprout grower.

### BRIEF DESCRIPTION OF THE DRAWINGS

Various embodiments of the invention are disclosed in the following detailed description and the accompanying drawings.

FIG. 1 is a diagram showing an embodiment of a seed development environment system.

FIG. 2 is a diagram showing an embodiment of a seed development environment device.

FIG. 3 is a flow diagram showing an embodiment of a process for providing a seed development environment.

FIG. 4 is a diagram of an example of a seed development environment device in accordance with some embodiments.

FIG. 5 is a diagram of an example of a seed development environment device in accordance with some embodiments.

FIG. 6 is a diagram of an example of a seed development environment device in accordance with some embodiments.

FIG. 7 is a diagram of an example of a seed development environment device in accordance with some embodiments.

FIG. 8 is a diagram of an example of a seed development environment device in accordance with some embodiments.

FIG. 9 is a flow diagram showing an example of a process for executing an environmental control sequence for seeds deposited within a seed development environment device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of a seed development environment system are described herein. In various embodiments, a seed development environment device is configured to provide, within it, a controlled microclimate to facilitate the germination of seeds and the growth of sprouts from the seeds. Where some seeds might have hard hulls, placing them in a moist environment softens the hulls and allows the sprouts to grow. After the sprouts are grown, they can be harvested and eaten, for example. The seed development environment device includes one or more modular seed repositories to hold seeds. The seed development environment device further includes a hydration system that provide hydration (e.g., moisture/humidity) to the seeds and also a hydration sensor to detect the hydration level inside the seed development environment device. For example, the hydration system is configurable to provide moisture/humidity to the seeds in the form of water droplets of one or more sizes. The seed development environment includes a control system that is configured to determine an environmental control sequence corresponding to the determined seed type of the seeds that are deposited into the seed repositories. In various embodiments, an environmental control sequence corresponds to a growing cycle of seeds to sprouts. In various embodiments, a growing cycle comprises a sequence of seed development phases. In various embodiments, the control system of the seed development environment device is configured to execute the determined environmental control sequence to provide target environmental conditions within the seed development environment device using at least the hydration system corresponding to each of the sequence of seed development phases. In various embodiments, hydration feedback within the seed development environment device that is measured by the hydration sensor is used by the control system to adjust at least the hydration level to modify the provided environmental conditions to meet the target hydration conditions. In some embodiments, in addition to the hydration system, the seed development environment device includes one or more other systems for providing environmental conditions within the seed development environment device such as, for example, but not limited to: a lighting system to provide one or more types of ultraviolet (UV) lighting, an air flow system to provide drying and/or cooling, and a temperature adjustment system to modify the temperature. In some embodiments, in addition to the hydration sensor, the seed development environment device includes one or more other types of environmental sensors for obtaining the current environmental feedback within the seed development environment device to adjust the provided environmental conditions. Examples of other types of environmental sensors include a temperature sensor, a camera, a pH sensor, and a light sensor.

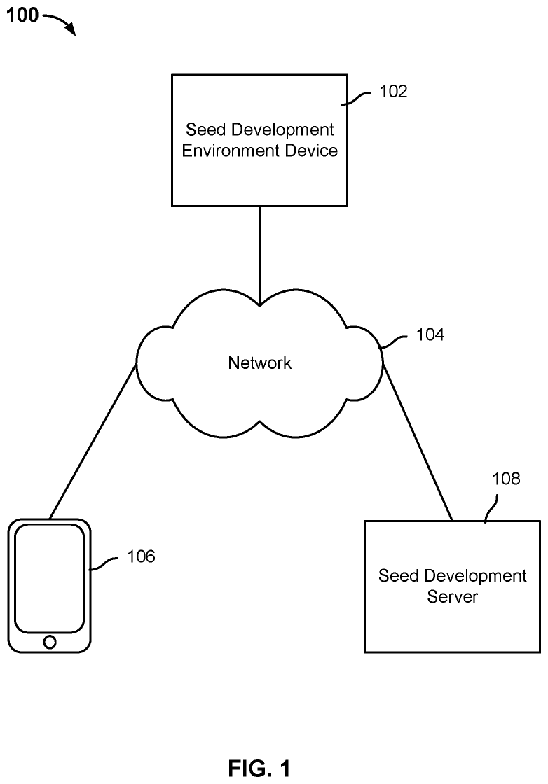

FIG. 1 is a diagram showing an embodiment of a seed development environment system. As shown in the example of FIG. 1, system 100 includes seed development environment device 102, network 104, client device 106, and seed development server 108. Network 104 includes data and/or telecommunications networks.

Client device 106 comprises a networked computing device. Examples of client device 106 include a smart phone, a tablet device, a desktop computer, or a laptop computer. Client device 106 is configured to execute a seed development environment application that is configured to provide a user interface associated with seed development environment device 102. For example, the seed development environment application is configured to send information (e.g., user input) to seed development environment device 102 and/or receive information from seed development environment device 102 that is to be presented at the user interface provided by client device 106. As will be described in further detail below, client device 106 is configured to receive notifications from seed development environment device 102 to indicate progress along its programmatic execution of a series of seed development phases that are described by an environmental control sequence corresponding to a seed type associated with the seeds that have been deposited within seed development environment device 102.

In some embodiments, the seed development environment application can also present information with the seeds that are undergoing the growing cycle such as the estimated harvest date, eat by date, the estimated yield, and the estimated nutritional content of the crop. In some embodiments, the seed development environment application can also maintain and present a sprouting calendar to assist the user in tracking when to deposit seeds into seed development environment device 102 and when to harvest the resulting sprouts. In some embodiments, the seed development environment application is configured to receive user input preferences (e.g., nutritional goals) and the application can recommend seed types that match the preferences and also an amount of seeds to result in the desired yield in sprouts. In some embodiments, the seed development environment application is configured to obtain user uploads of images of sprouts at various stages and send them to seed development server 108 for seed development server 108 to store as part of a social network related to the sprouting community.

In various embodiments, seed development environment device 102 is configured to communicate to client device 106 and seed development server 108. Seed development environment device 102 is configured to receive seeds that are manually deposited into seed repositories therein. Seed development environment device 102 is configured to obtain a seed type associated with the seeds that have been deposited into the seed repositories. In a first example, seed development environment device 102 is configured to obtain the seed type from client device 106. For example, a user using client device 106 can input the seed type into the seed development environment application and then client device 106 is configured to send the input seed type to seed development environment device 102. In a second example, seed development environment device 102 is configured to obtain a user input of a seed type via a user interface directly located on seed development environment device 102. In a third example, seed development environment device 102 is configured to scan a bar code (or another type of code) associated with a seed type via a scanning component directly located on seed development environment device 102. Based on at least the input seed type, seed development environment device 102 is configured to determine an environmental control sequence corresponding to the seed type. In various embodiments, the “environmental control sequence” corresponding to a seed type describes target environmental conditions and a target duration to be provided by seed development environment device 102 for seeds of that seed type for each seed development phase of a sequence of one or more seed development phases. The seed development phases are phases of seed germination and sprout growth. In various embodiments, the target environmental conditions for each seed development phase include at least a target hydration within the enclosed environment of seed development environment device 102. In some embodiments, the target environmental conditions for each seed development phase further include one or more of the following: a target temperature, a target amount of lighting, and a target amount of air flow within the enclosed environment of seed development environment device 102. After the environmental control sequence corresponding to the seed type is determined, seed development environment device 102 is configured to execute the first seed development phase providing the target environmental conditions as described for the first seed development phase in the environmental control sequence. Seed development environment device 102 is configured to provide the target environmental conditions by activating its one or more environmental systems. Examples of environmental systems include a hydration system, a temperature adjustment system, a lighting system, a ventilation system, and an air flow system.

During each seed development phase of the environmental control sequence, seed development environment device 102 is configured to obtain feedback from one or more environmental sensors located within seed development environment device 102 and/or around seed development environment device 102. Examples of such environmental sensors include a humidity sensor, a temperature sensor, a light sensor, a pressure sensor, and an air flow sensor. Based on the feedback (e.g., sensor readings) obtained from the environmental sensors, seed development environment device 102 is configured to adjust the execution of the environmental control sequence. For example, for a current seed development phase of an environmental control sequence, the sequence indicates that the target temperature inside seed development environment device 102 should be a target of 72 degrees Fahrenheit. However, if the hydration sensor inside seed development environment device 102 returns a reading of below the target of 72 degrees Fahrenheit, then seed development environment device 102 is configured to activate its temperature adjustment system to provide heat to the microclimate within seed development environment device 102 until the target temperature is detected by the temperature sensor. In various embodiments, the environmental control sequence states a target duration for each seed development phase. Seed development environment device 102 is configured to determine a current remaining duration associated with each seed development phase of the series of seed development phases that are described by the obtained environmental control sequence based on a function of the target duration as indicated for that seed development phase by the environmental control sequence. In some embodiments, seed development environment device 102 is configured to determine the current remaining duration of a seed development phase based on the target duration provided by the environmental control sequence and adjusted by the feedback from one or more sensors located inside and/or around seed development environment device 102. For example, seed development environment device 102 is configured to extend or shorten the remaining duration of the current seed development phase relative to the target duration based on the feedback from one or more sensors. The “target duration” therefore serves as a reference duration from which the remaining/actual duration of a seed development phase may be dynamically updated based on sensor feedback. In a specific example, when the measured/sensed temperature inside seed development environment device 102 is greater than the target temperature, then the remaining duration of the seed development phase is shortened and when the measured/sensed temperature inside seed development environment device 102 is equal to or less than the target temperature, then the remaining duration of the seed development phase is extended.

In some embodiments, seed development environment device 102 is configured to determine that when the remaining duration of the current seed development phase has elapsed, the current seed development phase has ended. In response to determining that the current seed development phase has ended, seed development environment device 102 is configured to output a corresponding notification (e.g., indicating the conclusion of the current seed development phase and a description of that seed development phase) at a user interface directly located on seed development environment device 102 or via network 104 to client device 106 for client device 106 to present the notification at the seed development environment application. Also, in response to determining that the current seed development phase has ended, seed development environment device 102 is configured to execute the next seed development phase by providing target environmental conditions as described for the next seed development phase in the environmental control sequence. Seed development environment device 102 is configured to iterate through each seed development phase as described in the environmental control sequence as described above. After seed development environment device 102 determines that the last seed development phase as described in the environmental control sequence has ended, seed development environment device 102 is configured to present an end of growing cycle notification at a user interface directly located on seed development environment device 102 or via network 104 to client device 106. For example, the end of growing cycle notification describes instructions for how a user can harvest the grown sprouts from the seeds that had been deposited inside seed development environment device 102 and/or instructions for how a user can clean seed development environment device 102.

In some embodiments, seed development environment device 102 is configured to receive user feedback before, during, or after the execution of any seed development phase of the environmental control sequence. For example, the user feedback may be input directly into a user interface that is located on seed development environment device 102 or input into the seed development environment application that is executing on client device 106. For example, the user feedback describes whether the remaining duration of the current seed development phase should be extended or shortened, a user observed condition of the environment within or around seed development environment device 102, and/or a desired growth goal (e.g., whether the sprouts should be taller or shorter) of the seeds. Seed development environment device 102 is configured to update the execution of the seed development phase that is relevant to the received user input. In some embodiments, seed development environment device 102 is configured to modify the obtained environmental control sequence for the obtained seed type based on the user feedback so that the user feedback can be incorporated into future executions of that environmental control sequence.

Seed development server 108 is configured to send updates such as, for example, updated environmental control sequences corresponding to various seed types or software/firmware updates to seed development environment device 102. In some embodiments, seed development server 108 is configured to obtain user feedback that is obtained at seed development environment device 102 from seed development environment device 102. Seed development server 108 is configured to collect user feedback or other collected data from multiple instances of seed development environment device 102 and can use the collected data to generate updated versions of environmental control sequences.

As shown in FIG. 1, seed development environment device 102 can be connected to client device 106 to enable the outputting of notifications. Furthermore, seed development environment device 102 is configured to dynamically modify the microclimate that it provides to its enclosed seeds to ensure the most suitable environment for their growth. Seed development environment device 102 is further in communication with seed development server 108 to enable remote updating of configuration information (e.g., environmental control sequences) as well as provide collected (e.g., user and/or sensor) feedback.

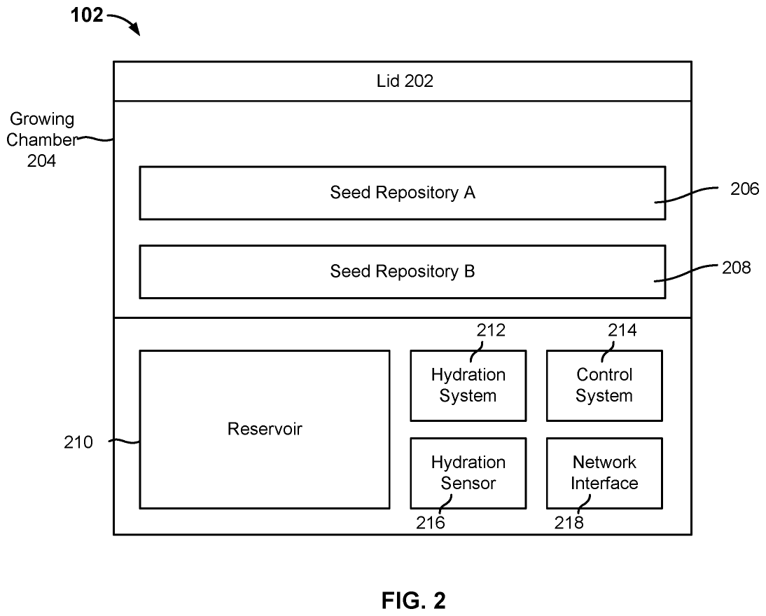

FIG. 2 is a diagram showing an embodiment of a seed development environment device. In some embodiments, seed development environment device 102 of FIG. 1 is implemented using the example of FIG. 2. As shown in FIG. 2, the example seed development environment is shown to include: lid 202, growing chamber 204, seed repository A 206, seed repository B 208, reservoir 210, hydration system 212, control system 214, hydration sensor 216, and network interface 218.

Lid 202 is a removable cover for the seed development environment device. Growing chamber 204 provides the housing for the seed repositories (e.g., seed repository A 206 and seed repository B 208) and the other mechanics that provide the microclimate of the seed development environment device. For example, lid 202 and/or growing chamber 204 can be made from glass or plastic. Lid 202 and/or growing chamber 204 may include an (e.g., adjustable) opening to provide ventilation inside the seed development environment device. To add seeds inside the seed development environment device, a user would open lid 202 and deposit seeds of a particular seed type into seed repository A 206 and seed repository B 208. While the example seed development environment device of FIG. 2 includes two seed repositories, a seed development environment device may include more or fewer seed repositories. For example, each of seed repository A 206 and seed repository B 208 is a seed tray that is designed to hold seeds and also retain moisture for the seeds.

In some embodiments, the seed development environment device is paired to a client device via network interface 218 and as such, the seed development environment device is configured to send notifications to and/or receive user input from the client device over a network or via wireless protocol such as Bluetooth.

After a user has deposited seeds into at least one of seed repository A 206 and seed repository B 208, the seed development environment device is configured to determine a seed type associated with the deposited seeds. Example seed types include, but are not limited to: broccoli seeds, alfalfa seeds, mung beans, and radish seeds. In some embodiments, control system 214 comprises at least a memory and a processor that is configured to obtain the seed type associated with deposited seeds as well as to instruct one or more environmental systems (including hydration system 212) within the seed development environment device to execute the environmental control sequence corresponding to the determined seed type. In some embodiments, control system 214 obtains the seed type associated with the deposited seeds based on a user input (e.g., a seed name or another value that identifies the seed type) that is input via the connected client device or input directly into a user interface (not shown) that is located on the seed development environment device. By inputting information (e.g., identifying information associated with the seed type) and viewing notifications at a user interface (not shown) that is located on the seed development environment device itself, a user can interact with the seed development environment device even without a network or a client device. In some embodiments, control system 214 is configured to determine the seed type based on an image that is generated by a camera (not shown) that is located inside growing chamber 204 and is pointed at the seeds deposited onto seed repository A 206 and/or seed repository B 208. For example, control system 214 is configured to input the obtained image of seeds into a trained model and to receive an output from the model of the determined seed type.

After the seed type corresponding to the deposited seeds is obtained, control system 214 of the seed development environment device is configured to obtain the environmental control sequence corresponding to that seed type. For example, environmental control sequences corresponding to different seed types are stored at the memory of control system 214. As mentioned above, in various embodiments, an environmental control sequence comprises computer instructions and/or other information that describes, at least, target environmental conditions and target durations for each seed development phase of multiple seed development phases of germination and sprout growth.

Control system 214 is configured to execute the first seed development phase that is described by the environmental control sequence by activating one or more environmental systems of the seed development environment device to provide the target environmental conditions associated with the first seed development phase. As shown in FIG. 2, the example seed development environment device includes hydration system 212, which is an environmental system that is configured to provide humidity and/or moisture from water reservoir 210 to the seeds in seed repository A 206 and seed repository B 208. While reservoir 210 is shown to be located below seed repository A 206 and seed repository B 208 in the example seed development environment system in FIG. 2, reservoir 210 can be located in various other configurations and locations within the seed development environment device. For example, reservoir 210 could be located on the side of the seed development environment device, on the top of the seed development environment device, or wholly external to the seed development environment device but connected to the seed development environment device via tubing. In some embodiments, hydration system 212 includes water pumps and/or one or more misters that are located in different locations within the seed development environment device. For example, the water pumps can be powered by an electric motor or by manual activation. For example, the misters can be located above and/or below seed repository A 206 and seed repository B 208. Besides misters, other examples of water distributing elements associated with hydration system 212 may include a pressure-based sprayer, drippers and related tubing, or a combination thereof. In some embodiments, hydration system 212 can be activated by control system 214 to provide humidity and/or moisture at variable degrees (e.g., where the degrees vary based on the size of the water droplets that are emitted by hydration system 212 and/or the length of time that hydration system 212 will emit water droplets within growing chamber 204). In some embodiments, hydration system 212 is configured to include shutters that are designed to distribute/direct the hydration to different locations within seed development environment device 400.

Control system 214 is configured to receive sensor feedback from one more types of sensors. As shown in FIG. 2, the example seed development environment device includes hydration sensor 216, which is a sensor that is configured to measure the humidity and/or moisture level within the seed development environment device. While control system 214 is configured to activate hydration system 212 to provide the expected amount of humidity and/or moisture to meet the target hydration level that is indicated in the environmental control sequence, feedback (e.g., the measured humidity level) that is provided by hydration sensor 216 is configured to measure the actual humidity level within the seed development environment device. Control system 214 is then configured to compare the measured actual humidity level within the seed development environment device against the target hydration level that is indicated in the environmental control sequence for the first seed development phase. If there is a discrepancy (e.g., within a predetermined tolerance) between the measured actual humidity level within the seed development environment device against the target hydration level that is indicated in the environmental control sequence, then control system 214 is configured to adjust the degree of hydration that is provided by hydration system 212 until the actual humidity level that is measured by sensor 216 within the seed development environment device meets the target hydration level (e.g., within a predetermined tolerance) that is indicated in the environmental control sequence.

Control system 214 is configured to execute the target environment conditions of the first seed development phase that are described by the environmental control sequence for a duration that is determined based on the target duration of the first seed development phase that is described ty the environmental control sequence. In various embodiments, control system 214 is configured to execute the first seed development phase for a duration that is the target duration modified by feedback received by one or more sensors of the seed development environment device. Put another way, control system 214 is configured to execute the first seed development phase of the environmental control sequence for a duration that is determined as a function of the target duration of the first seed development phase as stated in the environmental control sequence and the feedback (e.g., measurements) from one or more sensors associated with the seed development environment device. For example, the target duration stated by the environmental control sequence for the first seed development phase depends on the target hydration level being provided by the seed development environment device. As such, in the event that the measured actual humidity level within the seed development environment device is less than the target hydration level that is indicated in the environmental control sequence, control system 214 may extend the duration of the first seed development phase beyond the target duration as a function of the period of time that the measured actual humidity level is less than the target humidity level (e.g., because seeds germinate faster and/or sprouts grow faster with greater humidity).

After control system 214 determines that the determined duration of the first seed development phase that is described by the environmental control sequence has elapsed, control system 214 is configured to output a notification indicating the conclusion of the first seed development phase and the starting of the second/next seed development phase of the environmental control sequence for the determined seed type. In some embodiments, the notification is output to a user interface located on the seed development environment device. In some embodiments, the notification is output to a user interface located on the seed development environment device. In some embodiments, the notification is output to the client device and displayed via the seed development environment application. In some embodiments, the notification invites the user to submit user feedback in response to the current state of the seed development. For example, in response to the received notification, the user can see that the seeds within the seed development environment device are developing as expected (e.g., the appearance of the seeds at the current stage of germination or sprout growth matches an image of developing seeds/sprouts for the current seed development phase) and can therefore provide user feedback accordingly. In another example, in response to the received notification, the user can see that the seeds within the seed development environment device are not developing as expected (e.g., the appearance of the seeds and the current stage of germination or sprout growth are less developed than what is shown in an image of developing seeds/sprouts for the current seed development phase) and can therefore provide user feedback to indicate that the seed development environment device needs to execute the current seed development phase for longer. In response to such user feedback, control system 214 may update the remaining duration of the current seed development phase of the environmental control sequence to execute the seed development phase for an additional length of time. In some embodiments, in response to received user feedback to either shorten or lengthen the target duration of the current seed development phase of the environmental control sequence, control system 214 is configured to modify the target duration as indicated by the environmental control sequence for the current seed development phase to incorporate the user feedback. As such, the next time that control system 214 executes that environmental control sequence, the modified target duration for the current seed development phase will be used. After control system 214 determines that the determined duration of the first seed development phase that is described by the environmental control sequence has elapsed and no user feedback has been received to extend the first seed development phase, control system 214 is configured to execute the second seed development phase of the environmental control sequence in a manner similar to what was described above for the first seed development phase. Generally, earlier seed development phases in the environmental control sequence prescribe more humidity to soften the hull of the seeds to aide in germination and the later seed development phases of the environmental control sequence prescribe less humidity as sprouts that have already emerged from the seeds need less moisture to grow.

After control system 214 determines that the determined duration of the last seed development phase in the sequence of seed development phases that is described by the environmental control sequence has elapsed, then control system 214 is configured to output a notification indicating the conclusion of the entire environmental control sequence for the determined seed type. For example, this notification may include instructions on how to harvest the sprouts that have grown from the seeds and may also include instructions on how to clean the seed development environment device (e.g., how to empty and clean reservoir 210). For example, seed repository A 206 and seed repository B 208 may be removed from the seed development environment device and deposited directly in the fridge for storage and/or be used to present the sprouts for eating. Each of seed repository A 206 and seed repository B 208 is modular and can be swapped out with other instances of the same modular tray.

The example seed development environment device that is shown in FIG. 2 is only an example of such a device and in other examples, some of which will be described in further detail below, may include additional environmental systems in addition to the hydration system such as, for example, an air flow system, a temperature adjustment system, and a lighting system. Other example seed development environment devices may also include sensors in addition to the hydration sensor such as, for example, a camera, an air flow sensor, a thermometer, and a light sensor. Example seed development environment devices may include other features as well such as more than one water reservoir, a steam column, a seed repository elevator, an air filter, and a water filter to control the microclimate within the seed development environment device.

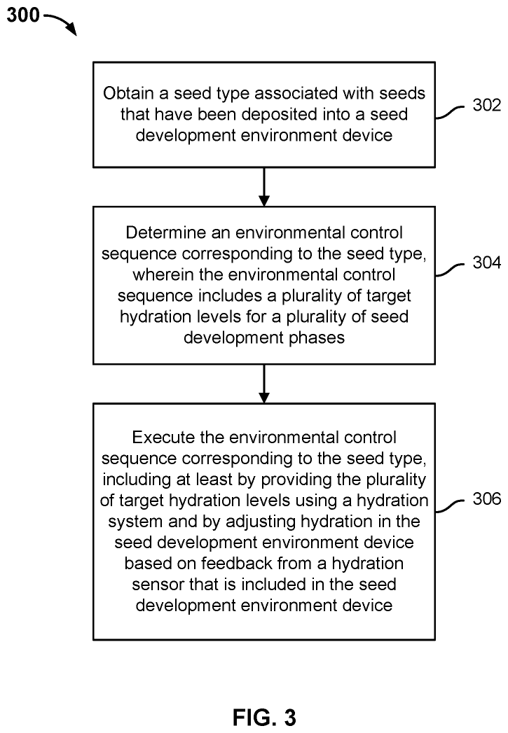

FIG. 3 is a flow diagram showing an embodiment of a process for providing a seed development environment. In some embodiments, process 300 is implemented at a seed development environment device such as seed development environment device 102 of FIG. 1.

At 302, a seed type associated with seeds that have been deposited into a seed development environment device is obtained. In some embodiments, the seed type (e.g., broccoli, alfalfa, radish, mung bean) is obtained based on a user input (e.g., a user input value). In some embodiments, the seed type is obtained by obtaining an image of the seeds (e.g., from a camera that is located inside the seed development environment device) and inputting the image into a trained model that is configured to recognize the seed type that appears in the image.

At 304, an environmental control sequence corresponding to the seed type is determined, wherein the environmental control sequence includes a plurality of target hydration levels for a plurality of seed development phases. For example, each seed development phase may correspond to a different target hydration level. In some embodiments, each seed type is associated with a corresponding environmental control sequence. As mentioned above, an environmental control sequence includes (e.g., executable computer instructions that describe) a sequence of two or more seed development phases, where each phase prescribes one or more target environmental conditions including a target hydration level to be provided by the seed development environment device to the seeds. For example, the target hydration level may include one or more of the following: a level of humidity, a size of water droplets to be used, the type of hydration to be provided (e.g., fogging, misting, spraying, or immersing the seeds in water), and/or a length of time to provide the hydration. In some embodiments, the environmental control sequence also prescribes a target duration for each seed development phase.

At 306, the environmental control sequence corresponding to the seed type is executed, including at least by providing the plurality of target hydration levels using a hydration system and by adjusting hydration in the seed development environment device based on feedback from a hydration sensor that is included in the seed development environment device. The environmental control sequence is executed by sequentially executing each seed development phase starting from the first phase until the last phase. Executing a seed development phase includes providing, inside the seed development environment device, at least the target hydration level that has been provided for that phase and adjusting the amount of hydration that is provided by the hydration system (e.g., misters, foggers, sprayers) in response to the feedback that is obtained by a hydration sensor (e.g., a humidity sensor) that is located inside the seed development environment device. Executing a seed development phase also includes providing at least the target hydration level for a target duration and determining whether to shorten or lengthen the target duration based on the feedback from at least the hydration sensor.

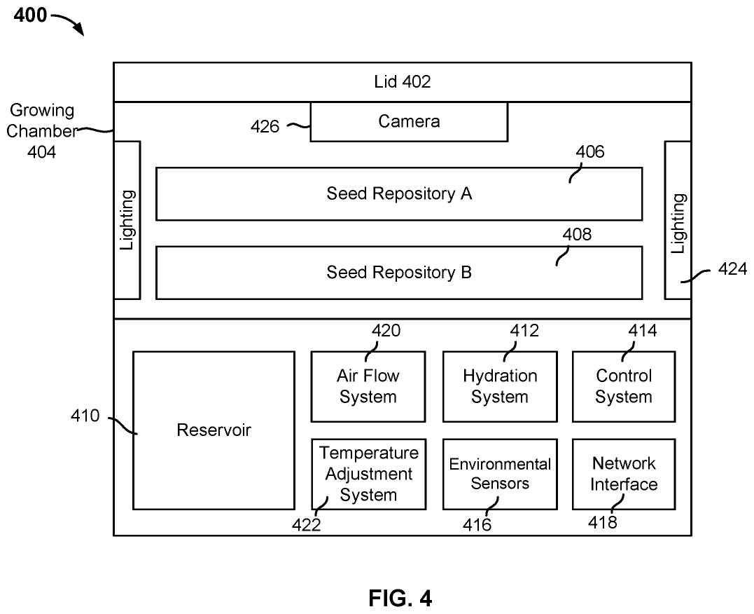

FIG. 4 is a diagram of an example of a seed development environment device in accordance with some embodiments. Seed development environment device 400 is similar to the example seed development environment device that was shown in FIG. 2, except that seed development environment device 400 includes some additional features. Seed development environment device 400 includes features such as lid 402, growing chamber 404, seed repository A 406, seed repository B 408, reservoir 410, hydration system 412, control system 414, and network interface 418, which function similarly to lid 202, growing chamber 204, seed repository A 206, seed repository B 208, reservoir 210, hydration system 212, control system 214, and network interface 218 that were described for the example seed development environment device that was shown in FIG. 2. In addition to the common features that were described in FIG. 2, seed development environment device 400 also includes camera 426, lighting system 424, air flow system 420, temperature adjustment system 422, and environmental sensors 416.

Camera 426 is configured to obtain images of the seeds deposited in seed repository A 406 and seed repository B 408. In some embodiments, control system 414 is configured to input the image into a first type of trained model to determine a seed type associated with the seeds. In some embodiments, control system 414 is configured to input the image into a second type of trained model to determine a current progress of growth associated with the seeds. In some embodiments, control system 414 is configured to send the image to a remote server (e.g., seed development server 108 of FIG. 1) for the remote server to analyze the image (e.g., to determine the current progress of growth associated with the seeds, whether there is mold on the sprouts, whether the sprouts need more water, whether the sprouts are ready to eat). In some embodiments, analysis (e.g., the current growth progress of the seeds, whether there is mold on the sprouts, whether the sprouts need more water, whether the sprouts are ready to eat) performed (e.g., locally by control system 414 or remotely by a seed development server) on images captured by camera 426 can be used as a form of sensor feedback to control system 414 that will cause an adjustment in the environmental conditions that are provided by control system 414 during the execution of a phase of the environmental control sequence.

Lighting system 424 is another environmental system that is controllable by control system 414 (e.g., when executing a phase of an environmental control sequence). In some embodiments, lighting system 424 may comprise UV-A, UV-B, and/or UV-C LEDs. While lighting system 424 is shown to be attached to be on the inside of growing chamber 404, in practice, the light(s) that make up lighting system 424 can be located anywhere within seed development environment device 400. For example, one or more UV-C LEDs can be deposited inside reservoir 410 to disinfect the water. In another example, one or more UV-A and/or UV-B LEDs can be deposited on the bottom of lid 402 and/or on the sides of the inside of growing chamber 404 to provide disinfection (e.g., against mold spores) and also simulate sunlight for improved sprout growth. In some embodiments, an environmental control sequence includes target lighting conditions to be provided during one or more seed development phases. To meet such target lighting conditions that are described by the environmental control sequence, control system 414 is configured to instruct lighting system 424 to provide a corresponding amount of light from each of its one or more lights. In some embodiments, environmental sensors 416 include a light sensor that is configured to detect an amount of light that is present within seed development environment device 400. In some embodiments, control system 414 is configured to instruct lighting system 424 to provide a corresponding amount of light from each of its one or more lights based on the feedback from the light sensor(s) to meet the target lighting conditions that are prescribed by the environmental control sequence for each seed development phase.

Air flow system 420 is an environmental system that is controllable by control system 414 (e.g., when executing a phase of an environmental control sequence). Air flow system 420 is configured to provide fresh air flow to the seeds deposited in seed repository A 406 and seed repository B 408 and also reduce potential mold spores. In some embodiments, air flow system 420 includes one or more fans and/or air ducts. In some embodiments, air flow system 420 is activated by control system 414 in conjunction with the activation of hydration system 412 to assist in the distribution of the hydration (e.g., ultrasonic mist, fog, spray) provided by hydration system 412. In some embodiments, air flow system 420 also comprises a ventilation system that is configured to provide ventilation into seed development environment device 400. For example, the ventilation system can be activated by control system 414 to allow more or less air from outside of seed development environment device 400 to flow into seed development environment device 400. In some embodiments, an environmental control sequence includes target air flow conditions to be provided during one or more seed development phases. To meet such target air flow conditions that are described by the environmental control sequence, control system 414 is configured to instruct air flow system 420 to provide a corresponding amount of air flow from each of its one or more fans/ducts. In some embodiments, environmental sensors 416 include an air flow sensor that is configured to detect an amount of air flow that is present within seed development environment device 400. In some embodiments, control system 414 is configured to instruct air flow system 420 to provide a corresponding amount of air flow from each of its one or more fans/ducts based on the feedback from the air flow sensor(s) to meet the target air flow conditions that are prescribed by the environmental control sequence for each seed development phase.

Temperature adjustment system 422 is an environmental system that is controllable by control system 414 (e.g., when executing a phase of an environmental control sequence). Temperature adjustment system 422 is configured to provide adjustments to the internal temperature within seed development environment device 400. In some embodiments, temperature adjustment system 422 includes a heating component and/or a cooling component. In some embodiments, temperature adjustment system 422 is activated by control system 414 in conjunction with the activation of air flow system 420 to assist in the distribution of the heat or cooling that is provided by temperature adjustment system 422. In some embodiments, an environmental control sequence includes target temperature conditions to be provided during one or more seed development phases. To meet such target temperature conditions that are described by the environmental control sequence, control system 414 is configured to instruct temperature adjustment system 422 to provide a corresponding amount of heat or cooling. In some embodiments, environmental sensors 416 include a temperature sensor (e.g., a thermostat) that is configured to detect a current temperature within seed development environment device 400 and optionally, a temperature sensor (e.g., a thermostat) that is configured to detect the ambient temperature outside of seed development environment device 400. In some embodiments, control system 414 is configured to instruct temperature adjustment system 422 to provide a certain amount of heat or cooling based on the feedback from the temperature sensor(s) to meet the target temperature conditions that are prescribed by the environmental control sequence for each seed development phase. Where the current temperature inside seed development environment device 400 is to be lowered slightly, alternative to activating the cooling component of temperature adjustment system 422, in some embodiments, control system 414 can be configured to activate air flow system 420 to generate air currents, which also serve the function of lowering the temperature within seed development environment device 400.

As described above, environmental sensors 416 may include a lighting sensor, an air current sensor, and/or a temperature sensor. Additionally, environmental sensors 416 may include a hydration sensor (similar to hydration sensor 216 of FIG. 2), an accelerometer (e.g., which could sense whether seed development environment device 400 is level or if an adjustment is needed), a water level sensor, an air quality sensor (e.g., which could sense the air quality inside seed development environment device 400 needs to trigger the activation of disinfection by lighting system 424), a pH sensor, and a total dissolved solids sensor. Feedback provided by any sensor within environmental sensors 416 can be used by control system 414 to adjust the execution of a seed development phase of an environmental control sequence. In some embodiments, each sensor of environmental sensors 416 is configured to periodically take measurements and send such feedback to control system 414 to process accordingly.

While not shown in FIG. 4, seed development environment device 400 may additionally include an air filter and/or a water filter. The air filter may contain carbon or other air filtering mechanisms to filter out mold or other contaminants into growing chamber 404. The water filter may reduce impurities and/or plant material that enters the water source in an effort to reduce bacterial load within reservoir 410.

While not shown in FIG. 4, seed repository A 406 and seed repository B 408 of seed development environment device 400 may accommodate the placement of seed pods, which are pods that include seeds. The design of the seed pods is to ensure that the seeds are deposited onto the repositories correctly and the pods themselves may include substances in addition to seeds such as substances that provide nutrients, support growth, and also reduce bacteria/mold. For example, a sprout pod is a small mesh bag containing seeds with a string attached that a user can put straight into a seed repository of seed development environment device 400.

While not shown in FIG. 4, in some embodiments, magnets are added to seed development environment device 400 to induce seed and sprout growth. These magnets can be added to growing chamber 404. Different types of magnets may be used including electric magnets. Alternatively, electric fields can be generated to induce seed and sprout growth.

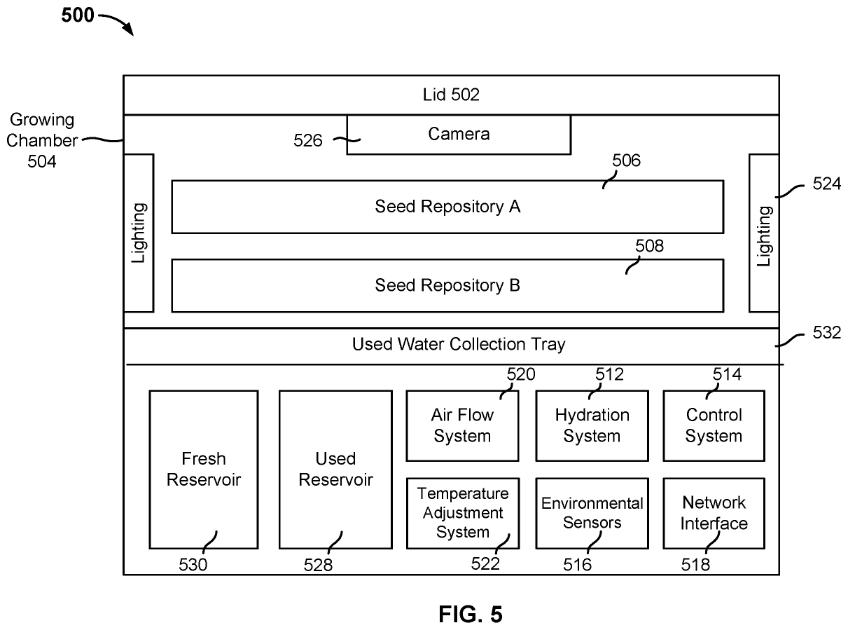

FIG. 5 is a diagram of an example of a seed development environment device in accordance with some embodiments. Seed development environment device 500 is similar to seed development environment device 400 that was shown in FIG. 4, except that seed development environment device 500 includes some additional features. Seed development environment device 500 includes features such as lid 502, growing chamber 504, seed repository A 506, seed repository B 508, hydration system 512, control system 514, environmental sensors 516, network interface 518, air flow system 520, temperature adjustment system 522, lighting system 524, and camera 526, which function similarly to lid 402, growing chamber 404, seed repository A 406, seed repository B 408, hydration system 412, control system 414, environmental sensors 416, network interface 418, air flow system 420, temperature adjustment system 422, lighting system 424, and camera 426 as described for seed development environment device 400 of FIG. 4. In addition to the common features that were already described in FIG. 4, seed development environment device 500 also includes fresh reservoir 530, used reservoir 528, and used water collection tray 532. By having two reservoirs, one (fresh reservoir 530) for holding fresh water and another (used reservoir 528) for holding water that is collected by used water collection tray 532, the fresh water can be segregated from the water that had been used for hydrating the seeds. In some embodiments, hydration system 512 can pump, draw, or otherwise provide water from fresh reservoir 530 to create hydration (e.g., mist, fog, spray, or dripping) for the seeds that have been deposited in seed repository A 506 and seed repository B 508. For example, the water that is not absorbed by the seeds or its resulting sprouts drips down into used water collection tray 532. The used water that is collected by used water collection tray 532 is then collected by used reservoir 528. As such, at the beginning of a growing cycle for seeds that have been deposited into seed repository A 506 and seed repository B 508, fresh reservoir 530 is manually filled with fresh water while used reservoir 528 is emptied (if it was not empty already). As control system 514 executes an environmental control sequence for a seed type determined for the seeds, fresh water will be removed from fresh reservoir 530 and/used water will be slowly collected in the initially empty used reservoir 528. One benefit to segregating the fresh water and used water in fresh reservoir 530 and used reservoir 528 is to discard the water that was previously used to hydrate the seeds and prevent it from being distributed again to the seeds/sprouts because the used water has a higher likelihood of including mold spores or other pathogens than fresh water.

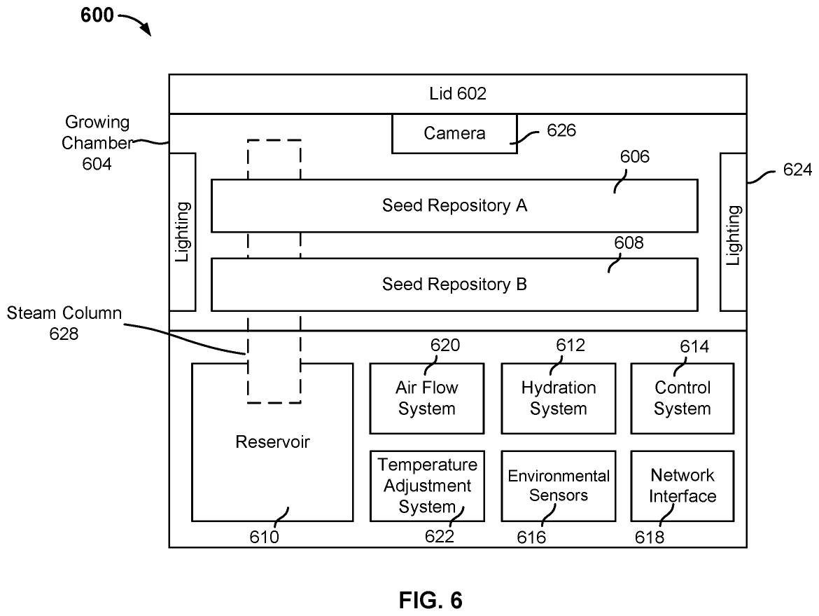

FIG. 6 is a diagram of an example of a seed development environment device in accordance with some embodiments. Seed development environment device 600 is similar to seed development environment device 400 that was shown in FIG. 4, except that seed development environment device 600 includes some additional features. Seed development environment device 600 includes features such as lid 602, growing chamber 604, seed repository A 606, seed repository B 608, reservoir 610, hydration system 612, control system 614, environmental sensors 616, network interface 618, air flow system 620, temperature adjustment system 622, lighting system 624, and camera 626, which function similarly to lid 402, growing chamber 404, seed repository A 406, seed repository B 408, reservoir 410, hydration system 412, control system 414, environmental sensors 416, network interface 418, air flow system 420, temperature adjustment system 422, lighting system 424, and camera 426 as described for seed development environment device 400 of FIG. 4. In addition to the common features that were already described in FIG. 4, seed development environment device 600 also includes steam column 628. As shown in FIG. 6, steam column 628 rises from reservoir 610 and extends above the highest seed repository (seed repository A 606) within seed development environment device 600. Steam column 628 is a hollow tubular structure with apertures over its surface and assists in distributing hydration vertically throughout seed development environment device 600 to ensure that the entire stack of seed repositories is able to receive hydration provided by hydration system 612, especially hydration that comprises smaller water droplets such as misting or fogging, for example. For example, hydration system 612 includes a pump that pumps generated ultrasonic mist or fog upwards through steam column 628 and steam column 628 helps steer the water droplets throughout the height of the stack of seed repositories and also allows the water drops to be distributed over each seed repository in the stack through its apertures.

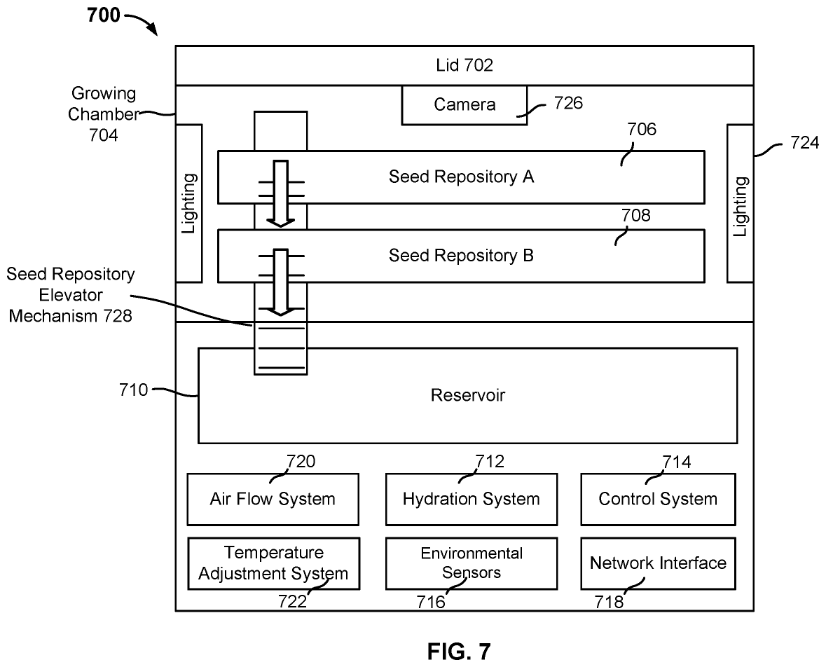

FIG. 7 is a diagram of an example of a seed development environment device in accordance with some embodiments. Seed development environment device 700 is similar to seed development environment device 400 that was shown in FIG. 4, except that seed development environment device 700 includes some additional features. Seed development environment device 700 includes features such as lid 702, growing chamber 704, seed repository A 706, seed repository B 708, reservoir 710, hydration system 712, control system 714, environmental sensors 716, network interface 718, air flow system 720, temperature adjustment system 722, lighting system 724, and camera 726, which function similarly to lid 402, growing chamber 404, seed repository A 406, seed repository B 408, reservoir 410, hydration system 412, control system 414, environmental sensors 416, network interface 418, air flow system 420, temperature adjustment system 422, lighting system 424, and camera 426 as described for seed development environment device 400 of FIG. 4. In addition to the common features that were already described in FIG. 4, seed development environment device 700 also includes seed repository elevator mechanism 728. As shown in FIG. 7, seed repository elevator mechanism 728 comprises a mechanism that is configured to adjust the height of seed repository A 706 and seed repository B 708. In some embodiments, seed repository elevator mechanism 728 is configured to lower one or both of seed repository A 706 and seed repository B 708 into the water of reservoir 710 to cause seed repository A 706 and seed repository B 708 to be at least partially immersed in the water. Bathing the seeds in the water of reservoir 710 is one example technique to provide hydration to the seeds. In some embodiments, seed repository elevator mechanism 728 is part of hydration system 712 and can be controlled by control system 714 to lower seed repository A 706 and seed repository B 708 into the water of reservoir 710 (e.g., during the execution of a phase within an environmental control sequence) and then to raise seed repository A 706 and seed repository B 708 out of the water of reservoir 710 after the seeds have been hydrated by the water of reservoir 710. Seed repository elevator mechanism 728 comprises motors and/or gears that enable the actuation of seed repository A 706 and seed repository B 708. In some embodiments, seed repository elevator mechanism 728 is configured to provide hydration to the seeds (through dipping the seeds in water) in addition to misting, fogging, dripping, and/or spraying-based hydration that is provided by hydration system 712.

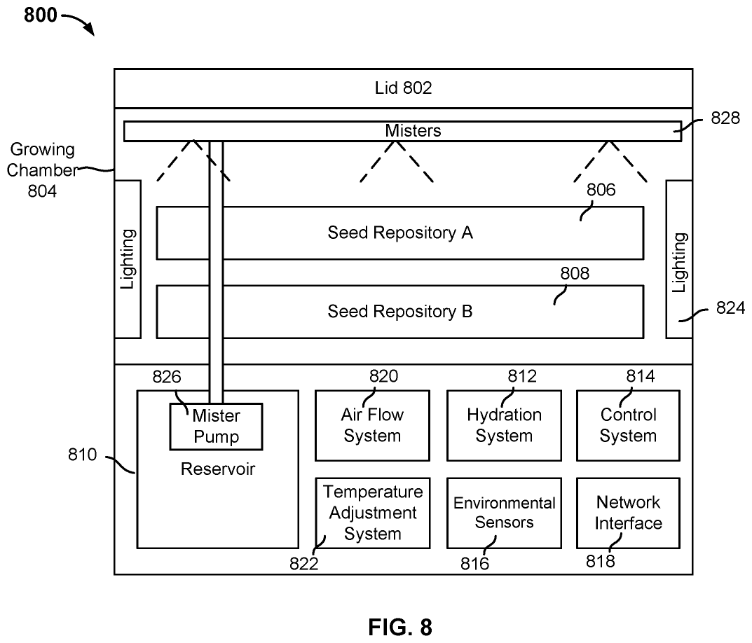

FIG. 8 is a diagram of an example of a seed development environment device in accordance with some embodiments. Seed development environment device 800 is similar to seed development environment device 400 that was shown in FIG. 4, except that seed development environment device 800 includes some additional features. Seed development environment device 800 includes features such as lid 802, growing chamber 804, seed repository A 806, seed repository B 808, reservoir 810, hydration system 812, control system 814, environmental sensors 816, network interface 818, air flow system 820, temperature adjustment system 822, and lighting system 824, which function similarly to lid 402, growing chamber 404, seed repository A 406, seed repository B 408, reservoir 410, hydration system 412, control system 414, environmental sensors 416, network interface 418, air flow system 420, temperature adjustment system 422, and lighting system 424 as described for seed development environment device 400 of FIG. 4. While seed development environment device 800 is not shown to include a camera, seed development environment device 800 may include a camera that functions similarly to camera 426 of seed development environment device 400. In addition to the common features that were already described in FIG. 4, seed development environment device 800 also includes mister pump 826 and misters 828. As shown in FIG. 8, mister pump 826 is configured to pump mist using the water from reservoir 810 into misters 828, which are placed above seed repository A 806 and seed repository B 808, so that misters 828 can release the mist/water droplets onto the seeds in seed repository A 806 and seed repository B 808 to provide hydration to the seeds. In some embodiments, mister pump 826 is part of hydration system 812 and is therefore also controlled by control system 814 to activate (e.g., during the execution of a phase of an environmental control sequence). For example, mister pumper 826 is configured to use pressure to release the mist using water that had been pumped up by mister pump 826. While misters 828 are shown in FIG. 8 to be located above seed repository A 806 and seed repository B 808, misters can be located in any other location relative to seed repository A 806 and seed repository B 808 within seed development environment device 800. For example, misters can be located along the inside of growing chamber 804 and/or beneath seed repository A 806 and seed repository B 808.

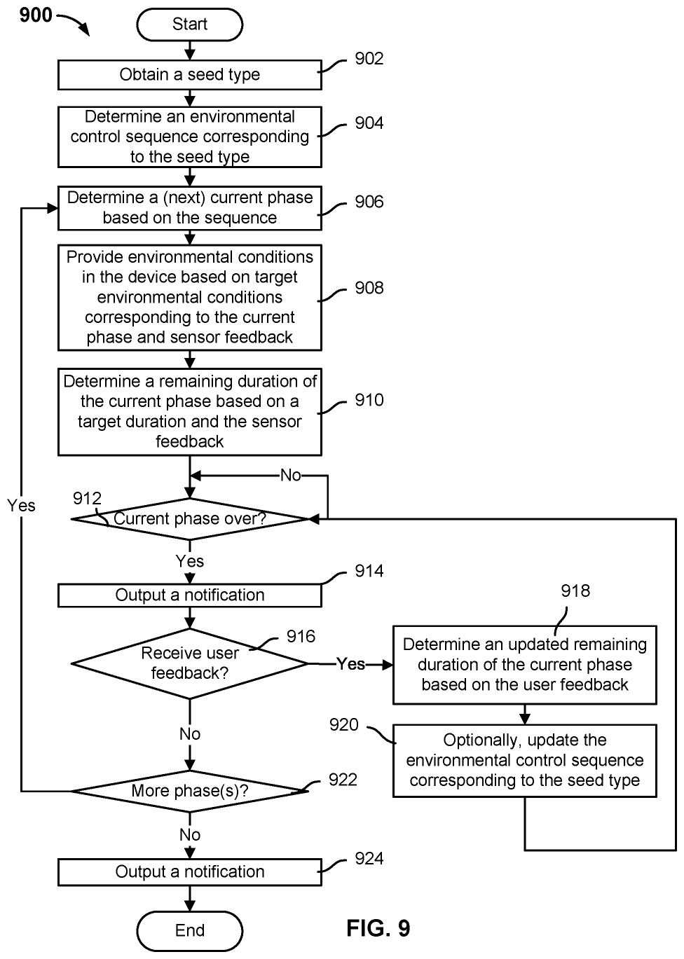

FIG. 9 is a flow diagram showing an example of a process for executing an environmental control sequence for seeds deposited within a seed development environment device. In some embodiments, process 900 is implemented at a control system of a seed development environment device (e.g., control system 214 of FIG. 2.).

At 902, a seed type is obtained. The seed type of the seeds that have been deposited into the seed development environment device is determined. For example, the seed type is associated with a type of plant/vegetable. Example seed types include broccoli, radish, alfalfa, mung bean, and soy bean. In some embodiments, the seed type is determined based on a user input (e.g., a user input of an identifier associated with the seed type). In some embodiments, the seed type is determined based on analyzing an image that is captured by a camera that is located inside the seed development environment device to determine the seed type that is associated with the seeds that are shown in the image.

At 904, an environmental control sequence corresponding to the seed type is determined. In various embodiments, different environmental control sequences corresponding to different seed types are locally stored at the seed development environment device or obtained from a remote server (e.g., a seed development server). The environmental control sequence corresponding to the seed type determined at 902 is obtained. As mentioned above, the obtained environmental control sequence describes target environmental conditions to provide for each phase of a sequence of multiple seed development phases that span the growing cycle of seeds of a certain type. Earlier phases in the sequence of seed development phases encourage the germination of the seeds (e.g., sprouts growing from seeds) and later seed development phases in the sequence promote the sprout growth. In a specific example, the later seed development phases include a dry phase (e.g., where the air flow system is activated to dry out the sprouts) and/or a dehydration phase (e.g., where the heating component of the temperature adjustment system is activated to dry the sprouts to allow them to last longer and also provide a pleasant flavor). In various embodiments, target environmental conditions include one or more of the following target hydration conditions: target air flow, target temperature, target water level, and/or target lighting conditions. To complete the growing cycle that is outlined by the environmental control sequence, the control system of the seed development environment device is configured to sequentially execute each seed development phase from the first phase to the last seed development phase.

At 906, a (next) current phase is determined based on the environmental control sequence.

At 908, environmental conditions are provided in the seed development environment device based on target environmental conditions corresponding to the current phase and sensor feedback. For each type of target environmental condition that is prescribed by the environmental control sequence, the control system is configured to activate a corresponding environmental system to provide a corresponding output.

In a first example, if the current phase includes a target hydration (e.g., humidity), then the control system is configured to activate the hydration system inside the seed development environment device to provide an initial/expected amount of hydration to meet the target hydration associated with the current phase. Sensor feedback (e.g., the actual hydration) is measured by the hydration sensor within the seed development environment device and based on the received measured actual hydration, the control system is configured to adjust the amount of hydration that is output by the hydration system, as needed, until the target hydration (e.g., a within a given tolerance) is measured by the hydration sensor.

In a second example, if the current phase includes a target temperature, then the control system is configured to activate the temperature adjustment system inside the seed development environment device to provide an initial/expected amount of heating or cooling to meet the target hydration associated with the current phase. Sensor feedback (e.g., the actual temperature) is measured by the temperature sensor within the seed development environment device and based on the received measured actual temperature, the control system is configured to adjust the amount of heating or cooling that is output by the hydration system, as needed, until the target temperature (e.g., within a given tolerance) is measured by the temperature sensor.

At 910, a remaining duration of the current phase is determined based on a target duration associated with the current phase and the sensor feedback. In some embodiments, the duration of the current phase (e.g., the length of time for which to provide the target environmental conditions for the current phase) is determined as a function of the target duration that is described by the environmental control sequence and the feedback provided by one or more types of environmental sensors within or external to the seed development environment device. In some embodiments, the control system is configured to store and apply logic that is configured to determine whether a discrepancy between a measured environment sensor feedback (e.g., the measured temperature or the measured hydration level) and the target environment sensor (e.g., the target temperature or the target hydration level) should lengthen the duration or shorten the target duration associated with the current phase. In a specific example, each time that a discrepancy is determined between the actual measured temperature within the seed development environment device and the target temperature associated with the current phase, the control system is configured to adjust the remaining duration of the current phase. As such, the computation of the remaining duration of the execution of the current phase is dynamically determined based on the feedback from the environmental sensors associated with the seed development environment device.

At 912, whether the current phase is over is determined. In the event that the current phase is over, control is transferred to 914. Otherwise, in the event that the current phase is not over, control is returned to 912. The current phase is determined to be over if the remaining duration of the current phase is zero. If less than all of the remaining duration has elapsed, then 912 is returned to (e.g., after waiting a predetermined number of seconds).

At 914, a notification associated with a conclusion of the current phase is outputted. In the event that the current phase is over, a corresponding notification is output. In some embodiments, the notification is output at a user interface that is located on the seed development environment device. In some embodiments, the notification is sent over a network and displayed within a seed development environment application that is executing at a client device. In some embodiments, this notification identifies the name of the concluded current phase and also the name of the next phase, if any, that is to be executed.

At 916, whether user feedback is received is determined. In the event that the user feedback is received, control is transferred to 918. Otherwise, in the event that user feedback is not received, control is transferred to 922. In some embodiments, the user feedback may be received from the user interface that is located on the seed development environment device. In some embodiments, the user feedback is received over a network from a seed development environment application that is executing at a client device. For example, the seed development environment application may present the notification associated with the conclusion of the current phase and also present a stored image that depicts what the seeds and/or its sprouts should look like at that stage. Then, the user can compare the actual appearance of the seeds and/or its sprouts inside the seed development environment device against the stored image to manually identify any issues. For example, an issue could be that the seeds/sprouts have not grown as much as they should have relative to the seeds/sprouts in the stored image. Based on that determination, the user may submit a user feedback comprising a request to extend the current phase for an additional (e.g., predetermined) length of time before proceeding to the next phase in the environmental control sequence.

At 918, an updated remaining duration of the current phase is determined based on the user feedback. In some embodiments, depending on the type of the user feedback, the remaining duration of the current phase is adjusted accordingly. In some embodiments, based on the user feedback that the seeds/sprouts need more time in the current phase, the current phase is executed for an additional, predetermined unit of time (e.g., 24 hours).

At 920, optionally, the environmental control sequence corresponding to the seed type is updated. In some embodiments, based on the user feedback, in addition to extending the execution of the current phase, a locally stored copy of the environmental control sequence may be updated such that the target duration that is included in the environmental control sequence for the current phase may be adjusted. This way, the next time that the local copy of the environmental control sequence for this same seed type is executed by the seed development environment, the target duration for the current phase would have already been updated to incorporate the user feedback. For example, it may be useful to incorporate the user feedback into the environmental control sequence because the user feedback may adapt the microclimate provided by the seed development environment device to the growth of the seeds/sprouts in a way that is specific to the user's preferences or to the user's specific ambient environment.

At 922, whether there is at least one more phase in the environmental control sequence is determined. In the event that there is at least one more phase in the environmental control sequence, control is returned to 906 where the next phase in the sequence is determined. Otherwise, in the event that there are no more phases in the environmental control sequence, control is transferred to 924. If the recently concluded phase is not the last phase that is described in the environmental control sequence, then step 906 is returned to to execute the next phase in the sequence.

At 924, a notification associated with a conclusion of the environmental control sequence is outputted. In the event all the phases of the environmental control sequence have been executed, a corresponding notification is output. In some embodiments, the notification is output at a user interface that is located on the seed development environment device. In some embodiments, the notification is sent over a network and displayed within a seed development environment application that is executing at a client device. In some embodiments, this notification provides instructions for the user on how to harvest the sprouts that have been grown in the seed development environment device and/or how to clean the device to prepare the device for a subsequent growing cycle with a new deposit of seeds.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A seed development environment device, comprising:
a seed repository;
a hydration system;
a hydration sensor;
a control system configured to:
determine a seed type associated with seeds that have been deposited into the seed development environment device; and
determine an environmental control sequence for the seeds, wherein the environmental control sequence includes a plurality of target hydration levels for a plurality of seed development phases; and
wherein the environmental control sequence is executed by providing the plurality of target hydration levels using the hydration system and by adjusting hydration in the seed development environment device based on feedback from the hydration sensor.

2. The seed development environment device of claim 1, wherein the hydration system comprises a water pump and a water distributor.

3. The seed development environment device of claim 2, wherein the water distributor comprises a mister, drip irrigation, and a sprayer.

4. The seed development environment device of claim 1, wherein a target hydration level comprises to lower the seed repository into a reservoir of water.

5. The seed development environment device of claim 1, further comprising an air flow system, wherein the environmental control sequence includes a plurality of target air flow levels for the plurality of seed development phases, and wherein the environmental control sequence is executed by providing the plurality of target air flow levels using the air flow system.

6. The seed development environment device of claim 1, further comprising a temperature adjustment system, wherein the environmental control sequence includes a plurality of target temperatures for the plurality of seed development phases, and wherein the environmental control sequence is executed by providing the plurality of target temperatures using the temperature adjustment system.

7. The seed development environment device of claim 1, further comprising a temperature adjustment system, wherein the environmental control sequence includes a plurality of target temperatures for the plurality of seed development phases, and wherein the environmental control sequence is executed by providing the plurality of target temperatures using the temperature adjustment system and by adjusting a temperature in the seed development environment device based on feedback from a temperature sensor.

8. The seed development environment device of claim 1, further comprising a lighting system, wherein the environmental control sequence includes a plurality of target lighting levels for the plurality of seed development phases, and wherein the environmental control sequence is executed by providing the plurality of target lighting levels using the lighting system.

9. The seed development environment device of claim 8, wherein the lighting system comprises one or more of the following: a UV-A light, a UV-B light, and a UV-C light.

10. The seed development environment device of claim 1, further comprising a network interface that is configured to send a notification or receive a user input over a network.

11. The seed development environment device of claim 1, further comprising a camera configured to generate an image of the seeds, and wherein the control system is further configured to determine the seed type associated with the seeds based at least in part on analyzing the image of the seeds.

12. The seed development environment device of claim 1, further comprising:
a fresh reservoir to hold fresh water, wherein the hydration is provided using the fresh water from the fresh reservoir;
a used water collection tray that is configured to collect used water; and
a used reservoir to hold the used water collected by the used water collection tray.

13. The seed development environment device of claim 1, further comprising a steam column configured to distribute the hydration over the seeds in the seed repository.

14. The seed development environment device of claim 1, wherein the hydration system comprises a seed repository elevator mechanism that is configured to lower and raise the seed repository into and out of a reservoir.

15. The seed development environment device of claim 1, wherein the control system is further configured to:
determine a remaining duration of a seed development phase based at least in part on a target duration and the feedback from the hydration sensor;
determine whether the remaining duration has elapsed; and
in response to a determination that the remaining duration has elapsed, output a notification.

16. The seed development environment device of claim 15, wherein the control system is further configured to:
receive a user input; and
update the environmental control sequence based at least in part on the user input.

17. A method, comprising:
obtaining a seed type associated with seeds that have been deposited into a seed development environment device;
determining an environmental control sequence corresponding to the seed type, wherein the environmental control sequence includes a plurality of target hydration levels for a plurality of seed development phases; and
executing the environmental control sequence corresponding to the seed type, including at least by providing the plurality of target hydration levels using a hydration system and by adjusting hydration in the seed development environment device based on feedback from a hydration sensor that is included in the seed development environment device.

18. The method of claim 17, further comprising:
determining a remaining duration of a seed development phase based at least in part on a target duration and the feedback from the hydration sensor;
determining whether the remaining duration has elapsed; and
in response to a determination that the remaining duration has elapsed, outputting a notification.

19. The method of claim 18, further comprising:
receiving a user input; and
updating the environmental control sequence based at least in part on the user input.

20. The method of claim 18, further comprising:
receiving a user input; and
updating the remaining duration of the seed development phase based at least in part on the user input.
